(19) United States
(12) Patent Application Publication
(10) Pub. No.: US 2012/0267011 A1
(43) Pub. Date: Oct. 25, 2012

(54) SULFUR TREATMENT FOR COPPER ZINC ALLOYS

(76) Inventor: Benjamin L. Lawrence, Elkhart, IN (US)

(21) Appl. No.: 13/302,374

(22) Filed: Nov. 22, 2011

Related U.S. Application Data
(60) Provisional application No. 61/478,749, filed on Apr. 25, 2011.

(51) Int. Cl. C23C 8/08; B32B 15/04

(52) U.S. Cl. 148/283; 148/400

(57) ABSTRACT

Brass components exhibiting excellent resistance to dezincification corrosion and stress corrosion cracking are prepared without, or with a reduced need for, corrosion inhibiting additives by developing a metal-sulfide rich barrier layer at the surfaces of the component. Brass components treated as disclosed exhibit corrosion resistance as determined by standardized testing that yields dezincification penetration less than 200 microns in depth and exhibits no stress corrosion cracking.

### CROSS-REFERENCE TO RELATED APPLICATIONS

This application claims priority under 35 U.S.C. §119(e) to U.S. Provisional Patent Application No. 61/478,749, filed Apr. 25, 2011, entitled “SULFUR TREATMENT FOR COPPER ZINC ALLOYS”, which is herein incorporated by reference in its entirety.

### FIELD OF THE INVENTION

The invention pertains to components or articles made of a copper zinc alloy which are resistant to dezincification.

### DESCRIPTION OF THE RELATED ART

Copper alloys containing zinc in an amount greater than approximately 15% by weight are susceptible to dezincification corrosion and stress corrosion cracking in aggressive environments. Dezincification corrosion and stress corrosion cracking is especially problematic for plumbing components where water chemistry can promote an oxidative attack on the zinc-rich constituent or phase within the alloy, leading to costly repairs due to in-service failures.

Conventional techniques for creating copper zinc alloys that are resistant to dezincification, corrosion and stress corrosion cracking generally involve lowering the zinc content, and/or adding ingredients that inhibit dezincification corrosion and stress corrosion cracking. Lowering zinc content generally requires increasing the copper content and increasing the cost of the alloy. Adding dezincification inhibiting ingredients can present undesirable production health risks and do not fully protect the alloy from corrosion. Further, many dezincification remedies often require special alloy processing steps or heat treatment that increases the cost and difficulties associated with manufacturing products from the alloys.

Generally, dezincification can be reduced by maintaining the zinc content below about 15% by weight and minimized by adding about 1% tin by weight, as is done with Admiralty brass (C44300) and Navel brass (C46400).

Adding less than about 0.1% by weight of arsenic, antimony or phosphorous provides further protection against dezincification of copper zinc alloys, provided the alloy has the single alpha-phase structure.

As a general rule, corrosion resistance decreases with increasing zinc content. A decrease in zinc content to less than about 15% is beneficial in reducing dezincification corrosion.

Often, copper zinc alloys treated with dezincification inhibitors such as arsenic, tin, antimony, and phosphorous, must be heat treated to cause the structural change necessary for corrosion resistance. The final product is considered to be corrosion resistant if it passes standardized testing that yields dezincification penetration less than 200 microns in depth and reveals no stress corrosion cracks. Inhibited copper zinc alloys require precise chemistry and process control that are not always easily verified in the final product without extension destructive testing.

Silicon-containing copper zinc alloys (C69300, and C87850) exhibit exceptional corrosion resistance. These alloys contain silicon, phosphorous, and a relatively low zinc content of approximately 21% by weight, providing an alloy that does not rely on special heat treatment. However, these silicon-containing alloys are relatively expensive as compared with other yellow brasses having a high zinc content.

It is recognized in the industry that the zinc content in brass is important because zinc is less expensive than copper and tin, such that increasing the percentage of zinc generally reduces the cost of the brass material. Further, high zinc content approaching 40%, has been reported to increase free-machining properties of yellow brass. Yellow brass without lead or other additives, such as bismuth, silicon, and/or phosphorous, is more difficult to machine as the zinc content decreases.

Many of the “lead-free” yellow brasses, both inhibited and non-inhibited, exhibit corrosion resistance that is in the immediate vicinity of the 200 microns depth limit used to distinguish corrosion resistant copper zinc alloys from those copper zinc alloys that are not considered corrosion resistant. This borderline corrosion resistance limits the usefulness of these alloys in certain applications.

Copper zinc alloys having a higher zinc content (such as from about 15% to about 35% by weight) can be made to exhibit reasonably good cold-workability. Such cold-work alloys are good candidates for press connection plumbing components when machining and corrosion issues are addressed.

Table 1 provides a listing of some of the prominent lead-free brasses that are commercially available. Most of these alloys have a relatively high zinc content, near 40% by weight, to improve machining. Arsenic and tin are used in certain alloys to improve corrosion resistance.

TABLE 1
YELLOW BRASS LEAD-FREE ALLOY CHEMISTRIES (Nominal %)

| | Copper | Lead | Tin | Iron | Nickel | Aluminum | Arsenic | Zinc |
|---|---|---|---|---|---|---|---|---|
| CW 509 02 - CuZn40 | 60 | <0.2 | <0.2 | <0.3 | <0.3 | <0.05 | — | 40 |
| (C27450) | | | | | | | | |
| CW510L - CuZn42 | 58 | <0.2 | <0.3 | <0.3 | <0.3 | <0.05 | — | 42 |
| CW511L - CuZn36As | 62 | <0.2 | <0.1 | <0.1 | <0.3 | <0.1 | .02-.15 | 38 |
| C44300 | 71 | <0.07 | 1 | — | — | — | .04 | 28 |
| C46400 | 60 | <0.2 | 0.7 | — | — | — | | 39.2 |
| C46500 | 60 | <0.2 | 0.7 | — | — | — | .04 | 39.2 |

Sulfur is not a traditional element of brass. However, a sulfur-based brass has been recently proposed as a replacement for leaded brass. A Japanese company is reportedly pursuing a patent on this alloy and is conducting performance testing at this time. Sulfur is added to this alloy, much like phosphorous in order to refine the grain structure and break machine chips.

### SUMMARY OF THE INVENTION

Certain embodiments of the invention relate to brass components having a metal-sulfide rich barrier at the surface of the component.

In certain embodiments of the invention, a corrosion resistant brass component is prepared by contacting surfaces of the component with a fluid containing labile sulfur. In particular embodiments, the fluid containing labile sulfur is a sulfuric acid solution. In certain other embodiments, the fluid containing labile sulfur is a sulfur-rich atmosphere.

### BRIEF DESCRIPTION OF THE DRAWINGS

FIG. 1 is a photograph showing the surface microstructure of a yellow brass (C46400) rod that has not been treated as described herein.

FIG. 2 is a photograph of the surface microstructure of another yellow brass (C46400) rod that has not been treated as described herein.

FIG. 3 shows a comparison of a PEX C37700 tee that has been treated as described herein, with one that has not been treated.

FIGS. 4a and 4b are close-up views of sulfur treated surfaces of yellow brass metals.

FIG. 5 is a photograph showing the surface microstructure of a treated C46400, sulfide-based layer.

FIG. 6 shows a comparison of a sulfur treated yellow brass after dezincification testing with a non-treated yellow brass after dezincification testing.

FIG. 7 is a photograph showing a corrosion penetration depth of less than 5 microns for a yellow brass sample that has been sulfur treated as described herein.

FIG. 8 is a photograph showing a corrosion penetration depth of more than 200 microns for a yellow brass sample that has not been sulfur treated.

FIG. 9 is a photograph showing that a sulfur treated tee fitting of C37700 yellow brass containing 38% zinc exhibited no evidence of corrosion affect after being exposed to standard dezincification chemical test exposure.

FIG. 10 is a photograph showing that a sulfurized treated C37700 yellow brass did not exhibit any cracking when subjected to a stress corrosion cracking test.

FIG. 11 is a photograph showing that an untreated C37700 yellow brass developed stress corrosion cracks when subjected to a stress corrosion cracking test.

FIG. 12 is an auger electron spectrographic surface survey of a sulfurized layer on a C37700 yellow brass cylinder.

FIG. 13 is an auger electron spectrographic depth profile of a sulfurized layer on a C37700 yellow brass cylinder.

FIG. 14 is a 1500× backscattering electron (BSE) image of a cross section of a sulfurized layer on a C37700 yellow brass cylinder.

FIG. 15 is an energy dispersive spectrograph (EDS) of area 1 in FIG. 3.

FIG. 16 is an energy dispersive spectrograph of line 2 in FIG. 3.

FIG. 17 is a cross sectional view of a valve having yellow brass components.

FIG. 18 is an elevational view of a section of a piping assembly having yellow brass fittings.

FIG. 19 is a perspective view of a faucet having yellow brass components.

### DESCRIPTION OF THE PREFERRED EMBODIMENTS

As used herein, the term “brass” encompasses alloys comprised of at least 50% copper and from about 5% to about 45% zinc.

The term “finished brass component” refers to an article, such as a plumbing component made of brass, such as by casting, extruding or forging.

A “metal-sulfide rich barrier” refers to a layer of material at the surface of a finished brass component that has a metal-sulfide content that is qualitatively and/or quantitatively different from that of the underlying bulk or mass of the finished brass component, as determined by auger electron spectroscopy, sputter depth profiles, scanning electron microscopy in conjunction with energy dispersive spectroscopy, and/or backscattered electron imaging, such as in a manner consistent with the examples described herein.

The term “fluid” as used herein refers to a compressible fluid, such as a liquid or gas.

The term “labile sulfur” refers to a sulfur compound in the fluid that is capable of reacting with metal at surfaces of a finished brass component to prepare a corrosion resistant component under suitable conditions, such as those disclosed herein.

The expression “standardized testing that yields dezincification penetration less than 200 microns in depth refers to the international organization for standardization method ISO6509 (ISO 1981).

The term “press connection plumbing component” refers to a plumbing component in which connection with tubing is achieved by pushing components together utilizing a mechanical press tool to generate sufficient force to join the component to the tubing. Press fitting technology relies on compressive strength and compression to form a plumbing connection. Press plumbing components often employ a sealing ring that is also compressed to create a permanent seal.

The term “sulfur-rich atmosphere” refers to a gaseous fluid containing a sufficient concentration or partial pressure of a labile sulfur-containing compound to be useful for generating a metal-sulfide rich barrier at the surface of a brass component when surfaces of the brass component are contacted with the sulfur-rich atmosphere under suitable conditions, such as those disclosed herein.

Generally, the brass components treated in accordance with the invention are inexpensive brass components that exhibit excellent resistance to dezincification corrosion and stress corrosion cracking. As such, the brass components have, and are prepared from alloys having, a relatively high zinc content, such as at least 15% by weight, or at least 33% by weight, or at least 40% by weight. However, the techniques of this invention may be employed to achieve a beneficial result using brass components having a lower zinc content, such as from 5% to 15% by weight.

In accordance with certain embodiments of the invention, inexpensive brass components exhibiting excellent resistance to dezincification corrosion and stress corrosion cracking can be obtained without the addition of corrosion inhibiting additives, such as arsenic, tin, antimony, and phosphorous. Nevertheless, in certain embodiments, the treatments in accordance with this invention may be beneficially employed on brass components prepared from alloys containing effective amounts of corrosion inhibiting additives such as arsenic, tin, antimony, and phosphorous.

The brass components, and the alloys used to prepare the brass components of this invention may optionally contain lead in an amount up to 0.25% by weight (e.g., from 0.05% to 0.25% by weight). Tin may be optionally incorporated in an amount from 0.5% to 1.5% by weight. Arsenic, antimony, and/or phosphorous can be optionally employed in an amount from 0.05% to 0.15% by weight.

Brass components having a metal-sulfide rich barrier at surfaces of the component can be prepared by contacting the surfaces of the finished brass component with a fluid containing labile sulfur. The resulting barrier makes the component resistant to dezincification oxidation and/or stress corrosion cracking. Suitable fluids containing a labile sulfur include sulfuric acid solutions and sulfur-rich atmospheres.

Suitable conditions for treating a finished brass component to impart corrosion resistance include immersing the component in a highly concentrated sulfuric acid bath (e.g., 40% sulfuric acid by weight in aqueous solution) at an elevated temperature for a suitable period of time. In general, higher concentrations and higher temperatures require a shorter treatment time, whereas lower concentrations and/or lower temperatures require longer treatment times. A suitable treatment temperature is from about 150° F. to 210° F., such as from 170° F. to 190° F., 170° F. to 185° F., or 179° F. to 181° F. Depending on the acid concentration and the bath temperature, a suitable treatment period may range from about 30 minutes to 24 hours. Other liquid solutions that may be used comprise dissolved hydrogen sulfide, alkali metal sulfides and/or alkaline earth metal sulfides.

Suitable sulfur-rich atmospheres that may be employed in processes of this invention include gaseous mixtures generated by combustion of potassium bisulfate, and/or gaseous mixtures comprising hydrogen sulfide. In order to accelerate the treatment process, the surfaces of the brass component are contacted with the sulfur-rich atmosphere at an elevated temperature and for a time sufficient to cause a reaction between the sulfur-containing compound and the metal at the surface of the brass component. A suitable treatment temperature is in the range from about 500° F. to about 1500° F., such as from 1100° F. to 1400° F., 1150° F. to 1350° F., or 1275° F. to 1325° F. A suitable treatment time may depend on the species of labile sulfur compound in the atmosphere, the concentration of the labile sulfur compound or compounds, and the treatment temperature. Suitable treatment times can range from about 15 minutes to 1 hour. Sulfur-rich, oxygen-free atmospheres, including vacuum and inert gas, appear to improve the sulfur-metal reaction, reducing treatment time and temperature, and increasing sulfur adsorption penetration.

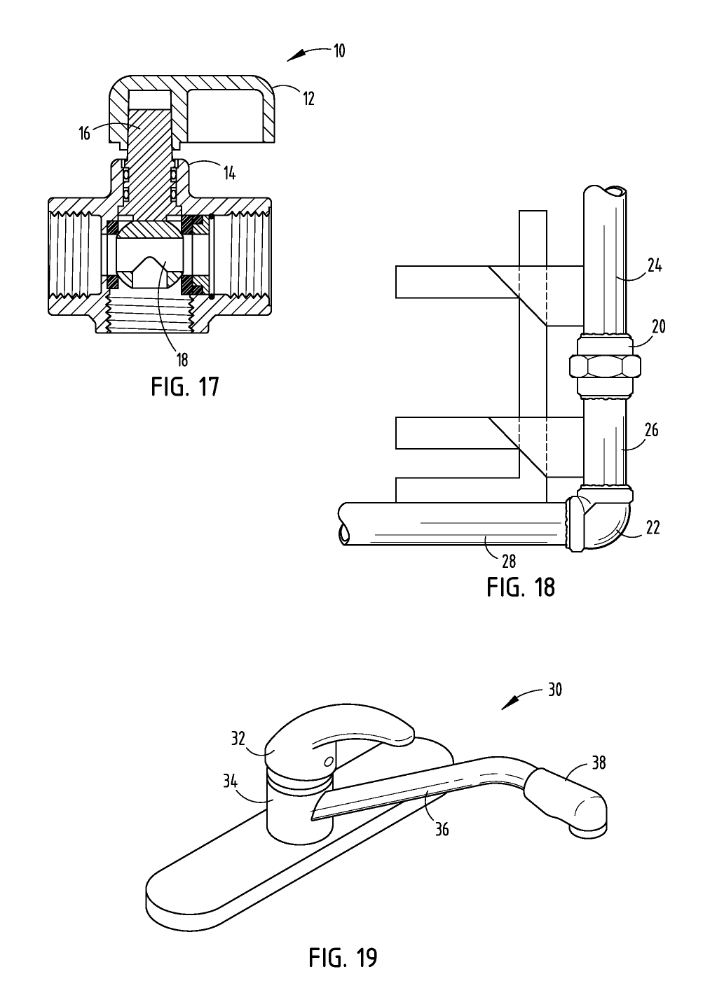

Examples of brass components that the processes of this invention may be beneficially employed on include various components configured for use as plumbing products, including: valve components, such as a handle 12, housing 14, spindle 16 and/or closure member 18 of a valve 10 (FIG. 17); plumbing fitting, such as union 20 and/or elbow 22 connecting pipe segments 24, 26, 28 (FIG. 18); and/or faucet components, such as valve handle 32, body 34, spout tube 36 and/or spout head 38 of faucet 30 (FIG. 19).

The disclosed sulfur treatment of copper alloys containing lead is expected to provide a benefit with regards to lead leaching for end-use components. This benefit is particularly important for either leaded alloys or those lead-free alloys with a low lead content but yet still maintain an undesirable level of lead leaching into potable waters. The benefits associated with creating a corrosion-resistant metal-sulfide are expected to be equally important with respect to creating a lead sulfide component that resists oxidation. This more stable lead-sulfide constituent is less likely to be given up to aggressive waters. Further, the combined benefit of corrosion resistance of both the zinc-rich and the segregate lead components of the alloy provides excellent advantage in reducing lead leaching to potable waters.

A better understanding of the invention can be obtained by consideration of the following non-limiting illustrative examples of the invention.

Material Comparison:

As-extruded C46400 rod was used for basic material comparison of treated and non-treated yellow brass. (See Table 1) The microstructure of treated and non-treated rod were compared. Dezincification testing was then conducted to determine corrosion resistance.

PEX C37700 fitting were also treated for comparison.

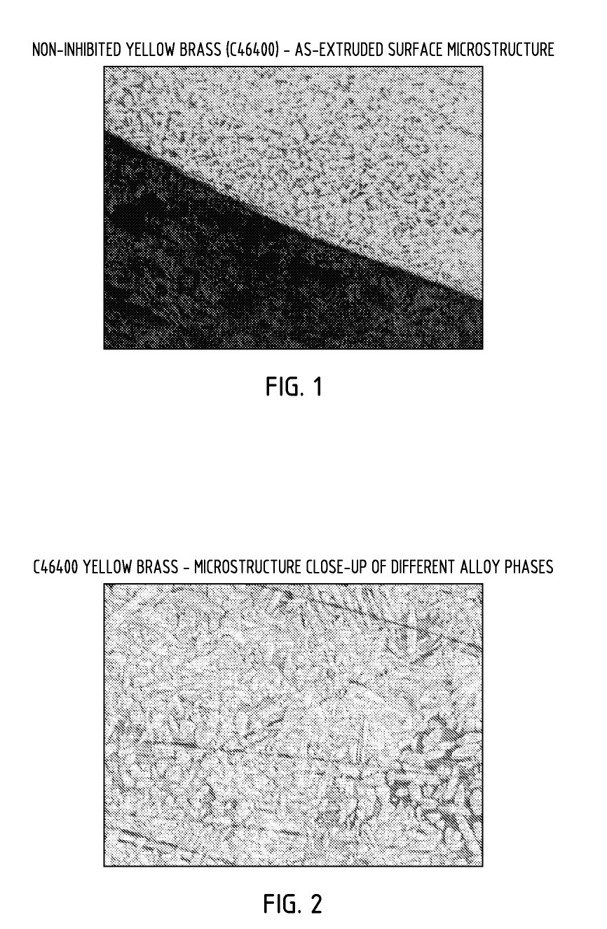

FIG. 1 shows non-treated C46400 microstructure, surface view.

FIG. 2 shows non-treated C464400 general microstructure (cross-sectional view).

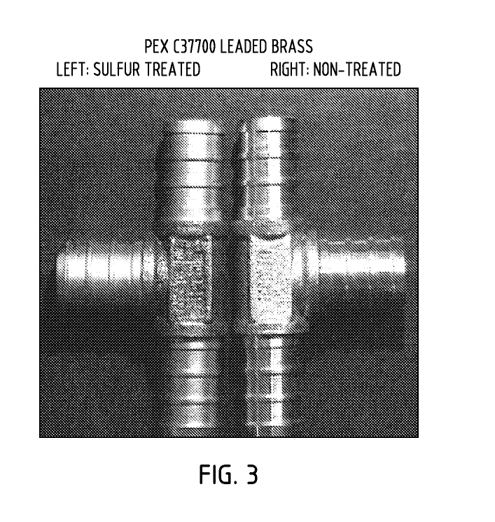

FIG. 3 shows a comparison with PEX C3770 Tees, Treated and Non-Treated.

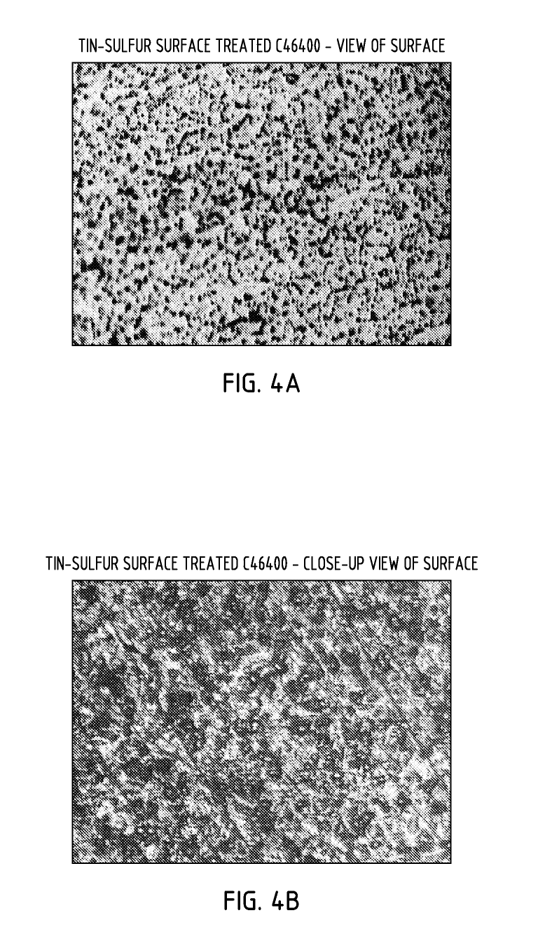

FIGS. 4a and 4b are close-Up Views of Sulfur Treated Surface.

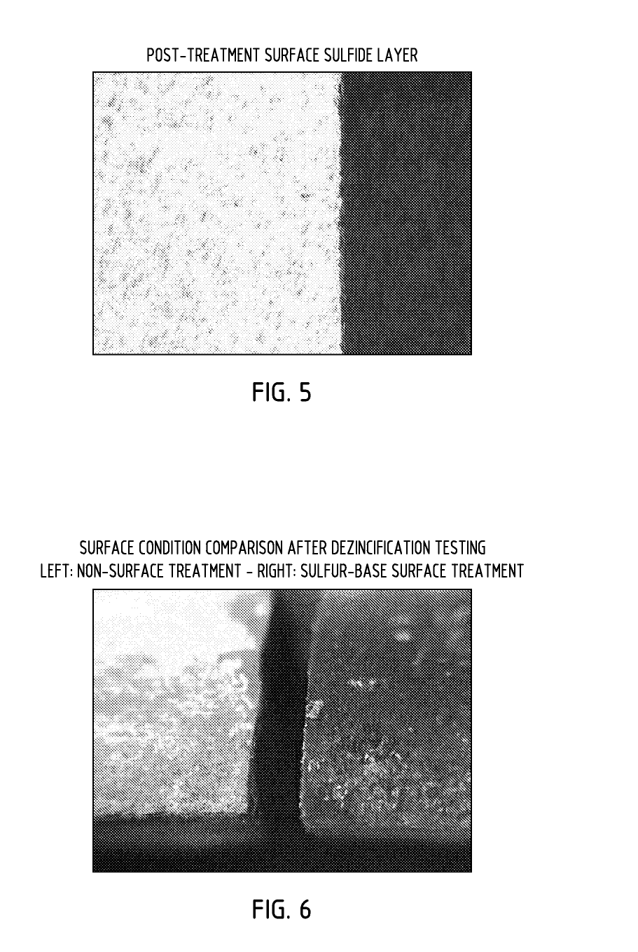

FIG. 5 shows a surface Microstructure View of Treated C46400, Sulfide-Based Layer.

FIG. 6 shows a comparison of Treated and Non-Treated Surfaces after dezincification Testing.

Results:

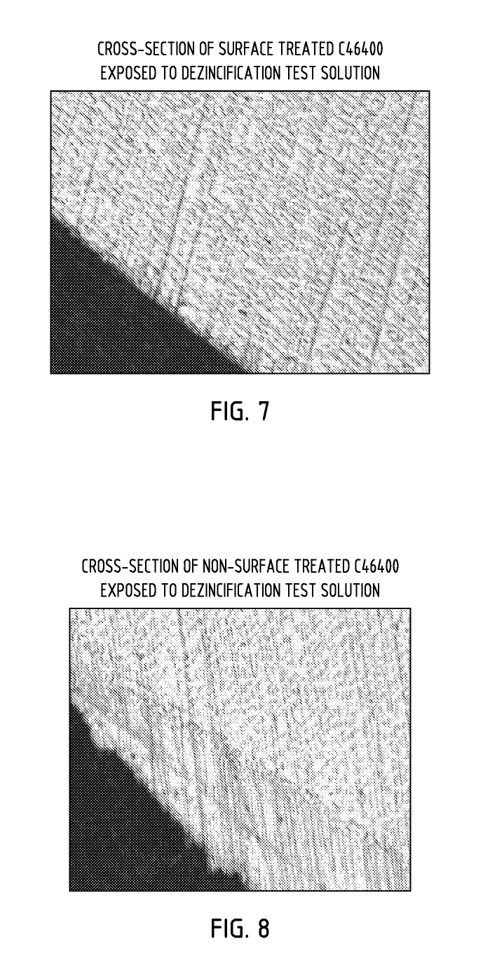

Dezincification corrosion resistance (DZR) testing has shown a consistent reduction in corrosion penetration over specimen runs. Most recent samples that were treated with the bath identified above provided corrosion penetration depth of less than 5 microns (FIG. 7). The non-treated C46400 samples consistently have dezincification penetration greater 200 microns the maximum allowable depth for DZR (FIG. 8).

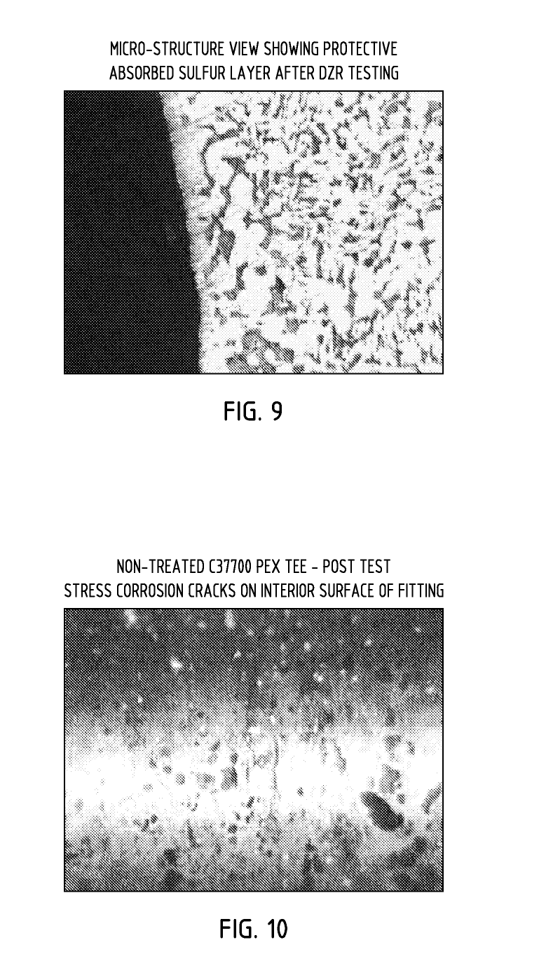

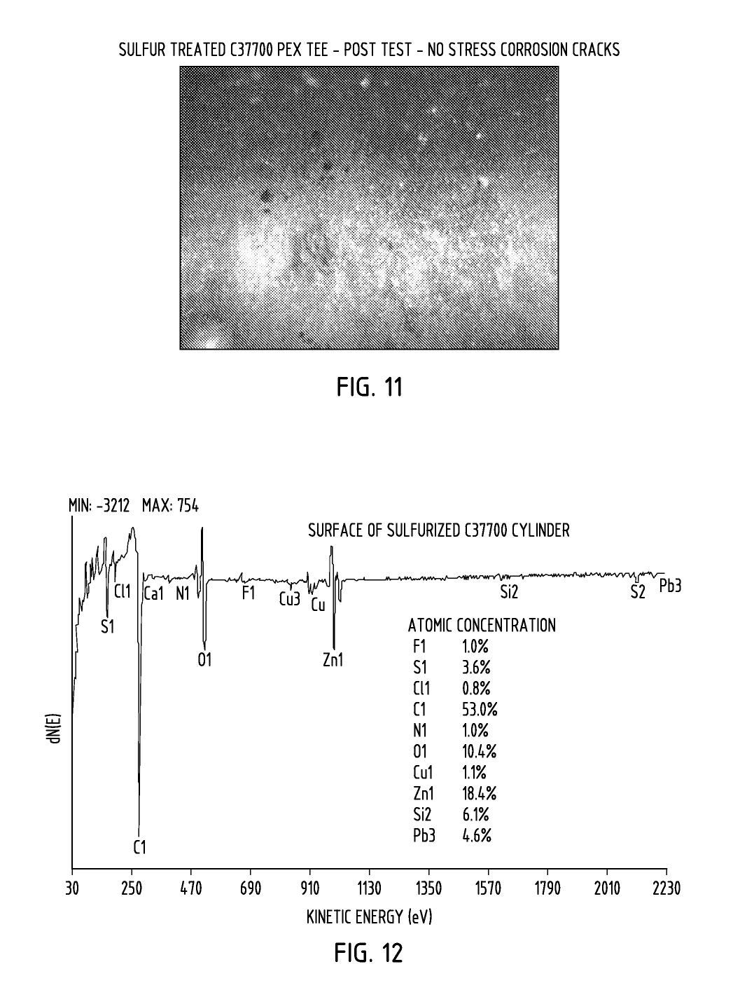

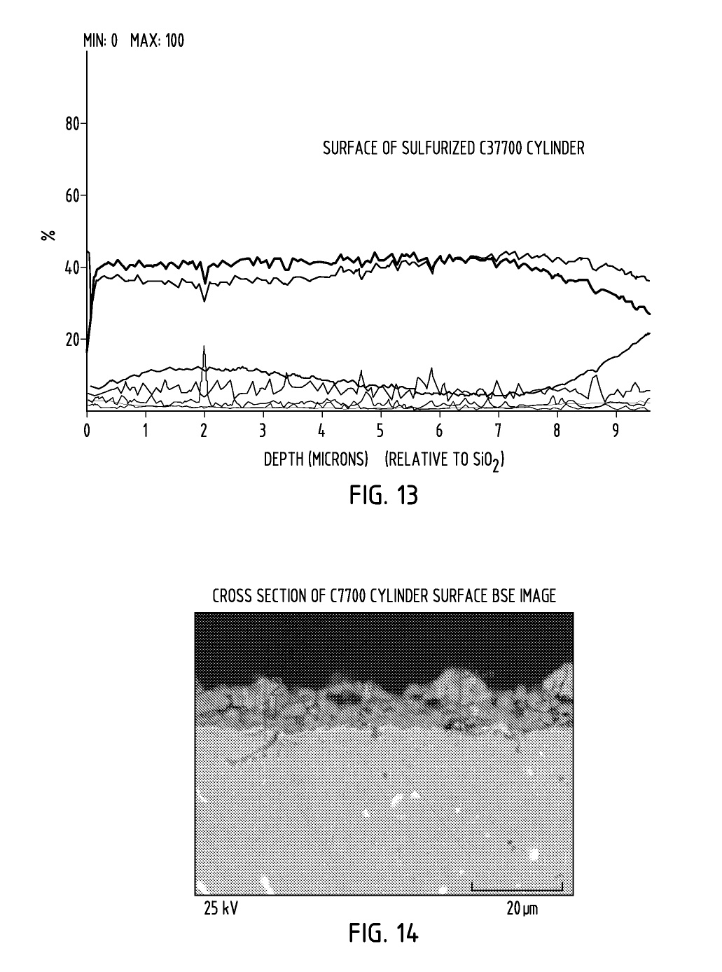

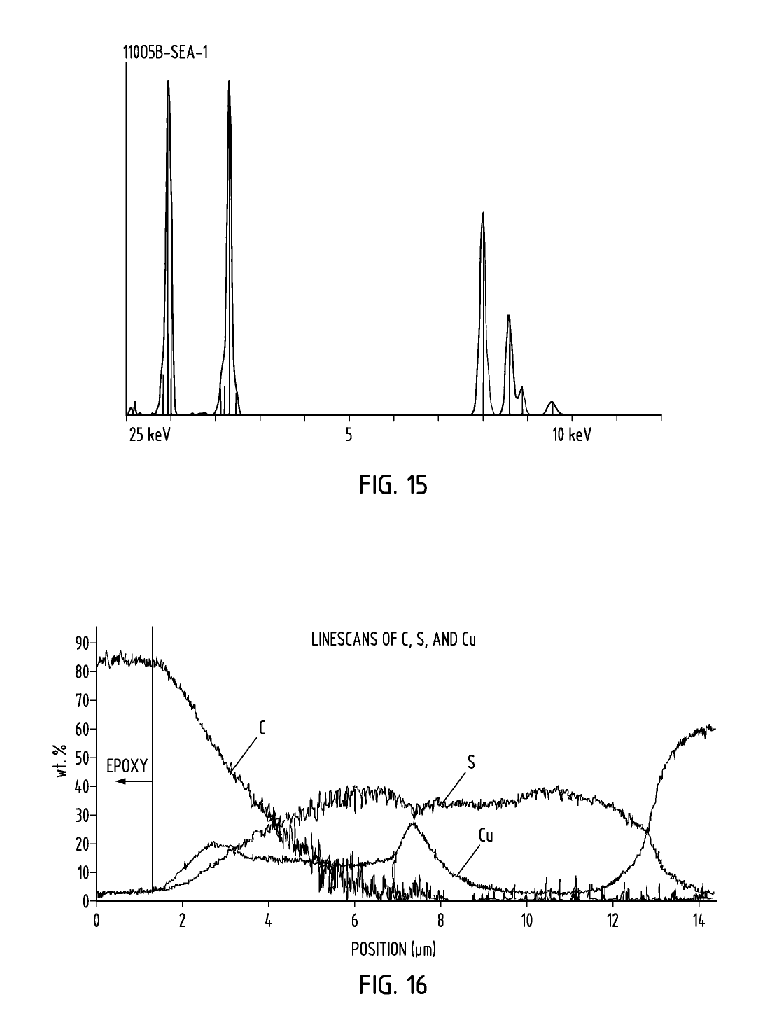

To demonstrate corrosion resistance, PEX tee fittings of C37700 yellow brass that contain 38% zinc were exposed to standard dezincification chemical test exposures with no evidence of corrosion attack. This product test followed earlier material specimen testing that had also showed resistance to dezincification corrosion (FIG. 9).

Next, a Stress Corrosion Cracking test was then conducted to compare resistance of sulfurized and non-sulfurized C37700 yellow brass. The results revealed no cracking for the sulfurized treated parts while the non-sulfurized parts developed stress corrosion cracks (FIGS. 10 and 11).

One cylinder of C37700 brass that had been subjected to a furnace sulfurization treatment was supplied for analysis. Analysis was requested on the blackened area on the flat end of the cylinder to determine the thickness, composition, and compositional profile of the sulfurized layer.

Analysis:

The cylinder end was sectioned by hand using a hacksaw. The blackened end was analyzed with auger Electron Spectroscopy (AES). AES is an elemental analysis techniques which is capable of detecting all elements except for H and He and has a nominal detection limit of ˜0.1 atom %. Spectral interferences may prohibit the detection of some elements in relatively low concentrations. The sampling volume of the measurement has a depth of ˜10 nm and an analysis area ˜500 μm in diameter. The quantification method assumes that the sampling volume is homogeneous, which is rarely the case; thus, tables of relative elemental compositions are provided as a means to compare similar samples and to identify contaminants and are not meant to provide accurate compositional data. Accurate quantification of data can be achieved through the use of well characterized reference materials of similar composition to the unknown sample. Compositional profiles (also called Sputter Depth Profiles (SDP)) were obtained by combining AES analysis with simultaneous sputter etching with a 3.5 keV Ar+ ion beam. Depth scales are referenced to the sputter rate for SiO₂. Depth scales are reported on this relative scale since all elements/compounds sputter at different rates. Relative sputter rates are useful for comparison of similar samples. More accurate sputter rates can be determined using a reference material of known or measurable thickness that is compositionally similar to the unknown sample. Sputter etching can cause apparent compositional changes in multi-element systems. All elements have different sputter rates, thus “differential sputter” can deplete the film of one or more of the constituent elements.

The coating was mounted in epoxy, ground, lapped with diamond films and polished.

The lapped cross section was coated with a thin (˜12 nm) coating of gold (Au) to facilitate analysis with Scanning Electron Microscopy in conjunction with Energy Dispersive Spectroscopy (SEM/EDS). SEM images depict topographic features of the sample surface. SEM imaging was performed at 25 keV. Backscattered Electron (BSE) imaging was also employed. Contrast in BSE imaging is sensitive to atomic number and density; thus, heavier elements and compounds appear brighter in the images than lighter elements and compounds.

EDS is an elemental analysis technique capable of detecting all elements except for H, He, Li, and Be with a detection limit of ˜0.1%. Spectral interferences may prohibit the detection of some elements in relatively low concentrations. The sampling volume is dependent on the accelerating voltage of the SEM, with a nominal analysis volume approximated by a sphere ˜1 μm in diameter at 20 keV. Lower accelerating voltages yield smaller sampling volumes. Quantification accuracy is good when the sampling volume is homogeneous and the compounds do not contain carbon or nitrogen. An EDS linescan was generated by acquiring spectra at each point along a line.

TABLE 2

| Figure | Description of Analysis |
|---|---|
| 12 | AES surface survey of sulfurized layer on C37700 cylinder |
| 13 | AES sputter depth profile of sulfurized layer on C37700 |
| | cylinder |
| 14 | 1500X BSE image of cross section of sulfurized layer on |
| | C37700 cylinder |
| 15 | EDS spectrum of Area 1 in FIG. 3 |
| 16 | EDS linescan of Line 2 in FIG. 3 |

Results and Interpretation:

TABLE 3
Relative Elemental Surface Composition of Sulfurized
Layer as Determined by AES Analysis.
[Atomic %]

| C | N | O | F | Si | S | Cl | Ca | Cu | Zn | Pb |
|---|---|---|---|---|---|---|---|---|---|---|
| 53 | 1.0 | 10 | 1.0 | 6.1 | 3.6 | 0.8 | <0.1 | 1.1 | 18 | 4.6 |

TABLE 4
Relative elemental Composition of Sulfurized
Layer as Determined by EDS Analysis.

| Composition Type | C | Al | Si | S | Cu | Zn | Au* |
|---|---|---|---|---|---|---|---|
| Weight % | 5.0 | 0.2 | 0.2 | 26 | 41 | 25 | 3.1 |
| Atomic % | 18 | 0.3 | 0.3 | 35 | 28 | 17 | 0.7 |

*From conductive layer on polished cross section

General Observations:
The layer thickness varies between about 9 μm and 12 μm (See FIG. 3).
Both the AES sputter depth profile and the EDS linescan suggest that the layer on the brass is a zinc sulfide (ZnS). The composition appears to vary with thickness some. The sulfur does not appear to be present into the brass bulk to some extent in the EDS linescan; however, it is important to remember that there is a 1 μm analysis volume that limits the spatial resolution with the EDS linescan.

What is claimed is:

1. A finished brass component having a metal-sulfide rich barrier at surfaces of the component.

2. A brass component in accordance with claim 1, in which the zinc content is at least 15% by weight.

3. A brass component in accordance with claim 1, in which the zinc content is at least 33% by weight.

4. A brass component in accordance with claim 1, having a lead content of 0.25% by weight or less.

5. A brass component in accordance with claim 1, having a tin content sufficient to reduce dezincification.

6. A brass component in accordance with claim 1, having a tin content of from 0.5% to 1.5% by weight.

7. A brass component in accordance with claim 1, having a single alpha-phase structure and an arsenic, antimony and/or phosphorous content sufficient to reduce dezincification.

8. A brass component in accordance with claim 1, having a single alpha-phase structure and at least one of arsenic, antimony and phosphorous in amount of from 0.05% to 0.15% by weight.

9. A brass component in accordance with claim 1, which is corrosion resistant as determined by standardized testing that yields dezincification penetration less than 200 microns in depth and exhibits no stress corrosion cracking.

10. A brass component in accordance with claim 9, which does not contain an amount of silicon or phosphorous that is sufficient to impart corrosion resistance.

11. A brass component in accordance with claim 1, that is corrosion resistant as determined by standardized testing that yields dezincification penetration less than 200 microns in depth and exhibits no stress corrosion cracking and which exhibits improved free-machining properties as compared with brass components comprising lead, bismuth, silicon and/or phosphorous in an amount sufficient to impart corrosion resistance.

12. A brass component in accordance with claim 1, having a zinc content of from 15% to 45% by weight that is configured for use as a press connection plumbing component.

13. A brass component in accordance with claim 1, which is configured for use as a plumbing product.

14. A brass component in accordance with claim 1, which is a valve component, a plumbing fitting, or a faucet component.

15. A brass component in accordance with claim 1, in which the medical-sulfide rich barrier is a layer having a thickness of from about 9 microns to 12 microns.

16. A process of making a corrosion resistant brass component comprising:
contacting surfaces of a finished brass component with a fluid containing labile sulfur.

17. A process in accordance with claim 16, in which the fluid containing labile sulfur is a liquid solution.

18. A process in accordance with claim 16, in which the fluid containing labile sulfur is a gaseous atmosphere.

19. A process in accordance with claim 17, in which the liquid solution is a sulfuric acid solution.

20. A process in accordance with claim 19, further comprising including a tin-containing compound in the sulfuric acid solution.

21. A process in accordance with claim 19, in which one or both of the brass component and the sulfuric acid are at an elevated temperature.

22. A process in accordance with claim 21, in which the elevated temperature is from 150° F. (65.6° C.) to 210° F. (98.9° C.).

23. A process in accordance with claim 21, in which the elevated temperature is from 170° F. (76.7° C.) to 190° F. (87.8° C.).

24. A process in accordance with claim 21, in which the elevated temperature is from 175° F. (79.4° C.) to 185° F. (85° C.).

25. A process in accordance with claim 21, in which the elevated temperature is from 179° F. (81.7° C.) to 181° F. (82.8° C.).

26. A process in accordance with claim 18, in which the surfaces of the brass component are contacted with a sulfur-rich atmosphere at an elevated temperature for a time sufficient to cause a reaction between the sulfur and the metal at the surface of the brass component.

27. A process in accordance with claim 26, in which the elevated temperature is from 500° F. (260° C.) to 1500° F. (815.6° C.).

28. A process in accordance with claim 26, in which the elevated temperature is from 900° F. (482.2° C.) to 1200° F. (648.9° C.).

29. A process in accordance with claim 26, in which the elevated temperature is from 1050° F. (565.6° C.) to 1150° F. (621.1° C.).

30. A process in accordance with claim 26, in which the elevated temperature is from 1075° F. (579.4° C.) to 1125° F. (607.2° C.).

31. A process in accordance with claim 26, in which the time is at least 15 minutes.

32. A process in accordance with claim 26, in which the sulfur-rich atmosphere is generated by combustion of potassium bisulfate.
